(19) United States
(12) Patent Application Publication
(10) Pub. No.: US 2025/0385473 A1
(43) Pub. Date: Dec. 18, 2025

(54) CONNECTOR

(71) Applicant: SUMITOMO WIRING SYSTEMS, LTD., Mie (JP)

(72) Inventor: Hiroaki TSUTSUMI, Mie (JP)

(21) Appl. No.: 19/228,226

(22) Filed: Jun. 4, 2025

(30) Foreign Application Priority Data
Jun. 13, 2024 (JP) 2024-095682

(51) Int. Cl. H01R 13/6581; H01R 13/42

(52) U.S. Cl. CPC H01R 13/6581; H01R 13/42

(57) ABSTRACT

A connector includes inner conductive bodies, dielectric bodies surrounding the inner conductive bodies, and an outer conductive body surrounding the dielectric bodies. Each inner conductive body has a substrate connection section arranged and exposed on a rear surface side of the dielectric body. The outer conductive body has an upper wall section, a pair of side wall sections protruding downward from a left and a right end portion of the upper wall section, and a partition wall section arranged between the pair of side wall sections. A space below the upper wall section and between the pair of side wall sections is partitioned into a plurality of accommodation spaces by the partition wall section. A rear section of each dielectric body and each substrate connection section are arranged in the respective one of the plurality of accommodation spaces.

### CROSS-REFERENCE TO RELATED APPLICATIONS

This application is based on and claims priority from Japanese Patent Application No. 2024-095682, filed on Jun. 13, 2024, with the Japan Patent Office, the disclosure of which is incorporated herein in its entirety by reference.

### TECHNICAL FIELD

The present disclosure relates to connectors.

### BACKGROUND

JP 2023-102174 A discloses a connector including a die-cast housing (corresponding to an outer conductive body), a contact (corresponding to an inner conductive body), and a support body that supports the contact (corresponding to a dielectric body). The support body is interposed between the housing and the contact so as to separate the contact from the housing. The contact has a substrate connection section that extends downward and rearward from the support body. The substrate connection section is configured to be brought into contact with a surface of a circuit board, and connected to the circuit board by soldering. The housing is provided with an inspection cut-away surface that faces diagonally downward. JP 2023-102174 A indicates that a camera is provided above and behind the housing to view the substrate connection section along a viewing passage parallel to the inspection cut-away surface, thereby inspecting the soldering of the substrate connection section to see whether it is good or defective.

JP 2023-18174 A discloses a connector including a terminal that is an inner conductive body, a die-cast member that is an outer conductive body surrounding the outer periphery of the terminal, and a dielectric body arranged between the terminal and the die-cast member. The terminal has a substrate connection section that extends downward and rearward from the dielectric body.

### SUMMARY

In JP 2023-102174 A, a single support body is provided in a single housing. Alternatively, for example, two supporting bodies may be provided in a single housing with the two supporting bodies arranged adjacent to each other in the left-right direction, and a plurality of contacts supported by each of the two supporting bodies may be arranged in the left-right direction. In that case, if the housing is provided with a single viewing passage through which the substrate connection sections of all contacts can be viewed at once, a region (cut-away region) where the viewing passage is created is so large that the shielding properties of the housing are likely to decrease.

With the above in mind, it is an object of the present disclosure to provide a connector in which, in the case in which a plurality of dielectric bodies are provided in an outer conductive body, a plurality of substrate connection sections can be inspected, and the shielding properties of the outer conductive body can be ensured.

A connector according to the present disclosure includes: inner conductive bodies; dielectric bodies surrounding the inner conductive bodies; and an outer conductive body surrounding the dielectric bodies. Each inner conductive body has a substrate connection section arranged and exposed on a rear surface side of the respective dielectric body. The outer conductive body has an upper wall section, a pair of side wall sections protruding downward from a left and a right end portion of the upper wall section, and a partition wall section arranged between the pair of side wall sections. A space below the upper wall section and between the pair of side wall sections is partitioned into a plurality of accommodation spaces by the partition wall section. A rear section of each dielectric body and each substrate connection section are arranged in the respective one of the plurality of accommodation spaces. A rear end of the upper wall section has a plurality of recessed portions arranged, corresponding to the respective ones of the plurality of accommodation spaces, and a partition section arranged between ones of the plurality of recessed portions adjacent to each other in a left-right direction.

According to the present disclosure, a connector can be provided in which, in the case in which a plurality of dielectric bodies are arranged in an outer conductive body, a plurality of substrate connection sections can be inspected, and the shielding properties of the outer conductive body can be ensured.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector according to a first embodiment.

FIG. 2 is a back view of the connector of the first embodiment.

FIG. 3 is a front view of a housing of the connector of the first embodiment.

FIG. 4 is a back view of the housing of the connector of the first embodiment.

FIG. 5 is a front view of an outer conductive body of the connector of the first embodiment.

FIG. 6 is a back view of the outer conductive body of the connector of the first embodiment.

FIG. 7 is an enlarged, cross-sectional top view of a continuous portion between the housing and outer conductive body of the connector of the first embodiment.

FIG. 8 is a perspective view of a surface-mounted terminal that is an inner conductive body of the connector of the first embodiment.

FIG. 9 is a perspective view of a through hole terminal that is an inner conductive body of the connector of the first embodiment.

FIG. 10 is a cross-sectional top view of the connector of the first embodiment in a state in which one dielectric body to which through hole terminals are attached is placed in one accommodation space, and another dielectric body to which surface-mounted terminals are attached is placed in another accommodation space.

FIG. 11 is a front view of a dielectric body of the connector of the first embodiment.

FIG. 12 is a back view of the dielectric body of the connector of the first embodiment.

FIG. 13 is a perspective view of the connector of the first embodiment in a state in which a dielectric body to which through hole terminals are attached and a dielectric body to which surface-mounted terminals are attached are arranged, facing the respective accommodation spaces of the outer conductive body.

FIG. 14 is an enlarged bottom view of the connector of the first embodiment in a state in which ground connection portions are arranged around substrate connection sections of through hole terminals, and ground connection portions are arranged around substrate connection sections of surface-mounted terminals.

FIG. 15 is an enlarged top view of the connector of the first embodiment in a state in which a rear section of the outer conductive body is linked to the housing.

FIG. 16 is a perspective view of the connector of the first embodiment.

FIG. 17 is a cross-sectional side view of the connector of the first embodiment in a state in which the dielectric body to which through hole terminals are attached is placed in the accommodation space of the outer conductive body.

FIG. 18 is a cross-sectional side view of the connector of the first embodiment in a state in which the dielectric body to which surface-mounted terminals are attached is placed in the accommodation space of the outer conductive body.

FIG. 19 is a perspective view of the connector of the first embodiment when states of substrate connection sections of through hole terminals arranged in one accommodation space and states of substrate connection sections of surface-mounted terminals arranged in another accommodation space are viewed from diagonally above the connector through recessed portions.

FIG. 20 is a cross-sectional top view of a connector according to a second embodiment in a state in which dielectric bodies to which through hole terminals are attached are placed in accommodation spaces.

FIG. 21 is a perspective view of the connector of the second embodiment when states of substrate connection sections of the through hole terminals arranged in the accommodation spaces are viewed from diagonally above the connector through recessed portions.

FIG. 22 is a cross-sectional top view of a connector according to a third embodiment in a state in which dielectric bodies to which surface-mounted terminals are attached are placed in accommodation spaces.

FIG. 23 is a perspective view of the connector of the third embodiment when states of substrate connection sections of the surface-mounted terminals arranged in the accommodation spaces are viewed from diagonally above the connector through recessed portions.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Explanation of Embodiments of the Present Disclosure

Firstly, enumerated exemplary embodiments of the present disclosure will be described below.

A connector according to the present disclosure is as follows.
(1) The connector includes: inner conductive bodies; dielectric bodies surrounding the inner conductive bodies; and an outer conductive body surrounding the dielectric bodies. Each inner conductive body has a substrate connection section arranged and exposed on a rear surface side of the respective dielectric body. The outer conductive body has an upper wall section, a pair of side wall sections protruding downward from a left and a right end portion of the upper wall section, and a partition wall section arranged between the pair of side wall sections. A space below the upper wall section and between the pair of side wall sections is partitioned into a plurality of accommodation spaces by the partition wall section. A rear section of each dielectric body and each substrate connection section are arranged in the respective one of the plurality of accommodation spaces. A rear end of the upper wall section has a plurality of recessed portions arranged, corresponding to the respective ones of the plurality of accommodation spaces, and a partition section arranged between ones of the plurality of recessed portions adjacent to each other in a left-right direction.

With the configuration of (1), a state of the substrate connection section (e.g., a soldering state of the substrate connection section with respect to a circuit board) can be checked from a position above and behind the connector through the recessed portion of the upper wall section. In particular, because the plurality of accommodation spaces, in which the rear portions of the respective dielectric bodies are arranged, are formed, and the partition section is arranged between the adjacent recessed portions, a decrease in the shielding properties of the outer conductive body can be reduced compared to the case in which the partition section is not provided. It should be noted that as described in (1), the partition section is formed in the upper wall section, and therefore, is distinguished from the partition wall section formed below the upper wall section because of different height positions thereof.
(2) In the connector described in (1), preferably, the partition section is formed above the partition wall section and is continuous to the partition wall section.

With the configuration of (2), the partition section is integrally formed with the partition wall section, and therefore, the strength of the partition section can be improved compared to the case in which the partition section and the partition wall section are separately formed.
(3) In the connector described in (1) or (2), preferably, an imaginary straight line extending upward and rearward from a rear end position on a circuit board of the substrate connection section and passing through the recessed portion is inclined within the range of 45 to 80 decrees with respect to a front-back direction.

With the configuration of (3), a state of the substrate connection section can be easily viewed from a position above and behind the connector in a direction along the imaginary straight line. In addition, the range in which the recessed portion is formed at the upper wall section can be reduced to an appropriate range so that the imaginary straight line is inclined at the above angle, and therefore, the shielding properties of the outer conductive body can be more reliably ensured.
(4) In the connector described in (3), the inner conductive bodies may be a surface-mounted terminal having the substrate connection section extending downward and rearward from the dielectric body.

With the configuration of (4), a state of the substrate connection section of the surface-mounted terminal can be easily viewed from a position above and behind the connector in a direction along the imaginary straight line.
(5) In the connector described in (3), the inner conductive bodies may be a through hole terminal having the substrate connection section extending downward from the dielectric body.

With the configuration of (5), a state of the substrate connection section of the through hole terminal can be easily viewed from a position above and behind the connector in a direction along the imaginary straight line.
(6) In the connector described in (3), the inner conductive bodies may be a surface-mounted terminal having the substrate connection section extending downward and rearward from the dielectric body, and a through hole terminal having the substrate connection section extending downward from the dielectric body.

With the configuration of (6), even in the case in which the through hole terminal and the surface-mounted terminal coexist, a state of the substrate connection section of each of the surface-mounted terminal and the through hole terminal can be easily viewed from a position above and behind the connector in a direction along the imaginary straight line.
(7) In the connector described in (6), the through hole terminal may be arranged in one of the plurality of accommodation spaces, and the surface-mounted terminal may be arranged in another of the plurality of accommodation spaces. The dielectric bodies having the same shape may be placed in the respective ones of the plurality of accommodation spaces.

With the configuration of (7), even in the case in which the through hole terminal and the surface-mounted terminal coexist, the identical dielectric body can be used for both of the terminals, and therefore, the manufacturing cost and management cost of the dielectric bodies can be reduced.

In the connector described in any of (1) to (7), preferably, a recessed end of the recessed portion has a vertical surface arranged vertically at an upper portion of the upper wall section, and an inclined surface arranged at a lower portion of the upper wall section and inclined downward and forward from the vertical surface.

With the configuration of (8), the recessed end of the recessed portion has the inclined surface in addition to the vertical surface, and therefore, visibility when a state of the substrate connection section is viewed from a position above and behind the connector can be improved. In addition, by adjusting the position in the front-back direction of the vertical surface at the upper wall section, both the shielding properties and the visibility can be obtained.

### Details of Embodiments of the Present Disclosure

Specific examples of the present disclosure will be described below with reference to the accompanying drawings. It should be noted that the scope of the present invention is defined by the appended claims rather than by the embodiments disclosed herein, and all meanings equivalent to the claims and all modifications made within the scope should be intended to be included therein.

### First Embodiment

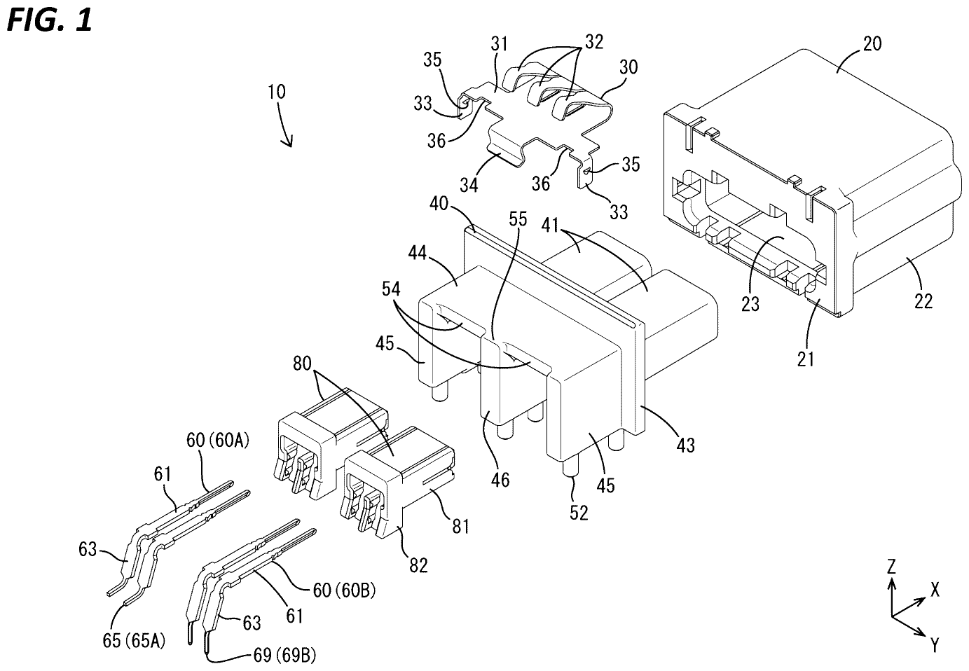

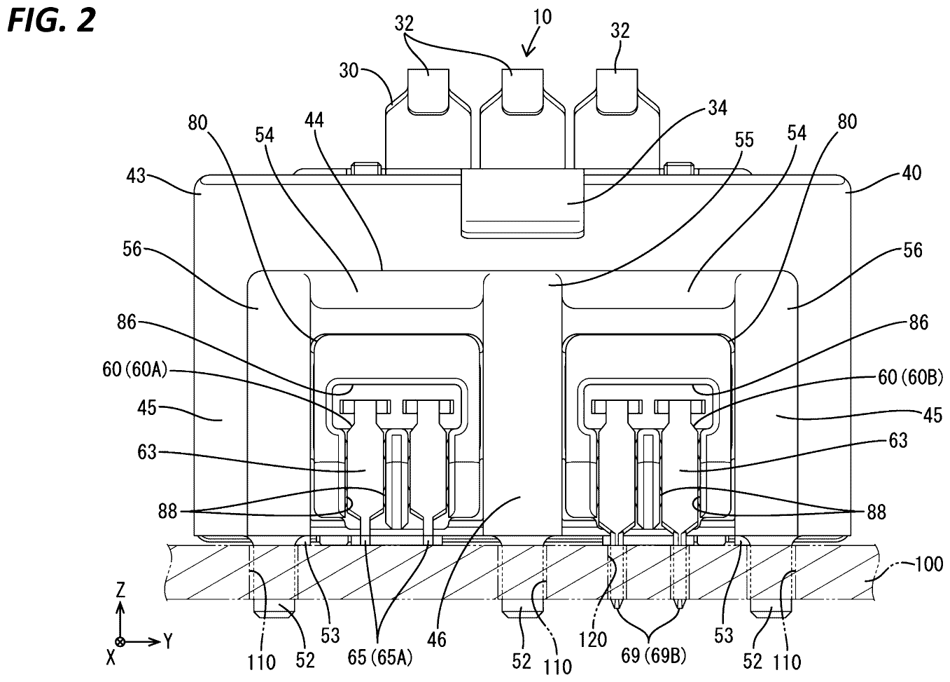

As illustrated in FIG. 1, a connector 10 according to a first embodiment of the present disclosure, which is a so-called shielded connector, includes a housing 20, an outer conductive body 40, inner conductive bodies 60, dielectric bodies 80, and a connection member 30. The housing 20 is configured to be fitted with a mating connector (not illustrated). As illustrated in FIG. 2, the inner conductive bodies 60 are configured to be electrically connected to conductive portions of a circuit board 100. The outer conductive body 40 is configured to be mounted on the circuit board 100. It should be noted that in the description that follows, concerning forward and rearward directions (front-back direction), the frontward direction is defined as a direction in which the housing 20 is configured to be fitted with a mating connector. Upward and downward directions (top-bottom direction) are based on the upward and downward directions (top-bottom direction) in FIGS. 1 and 2. Reference characters X, Y, and Z in FIGS. 1 and 2 indicate the frontward direction, leftward direction, and upward direction, respectively.

### (Housing 20)

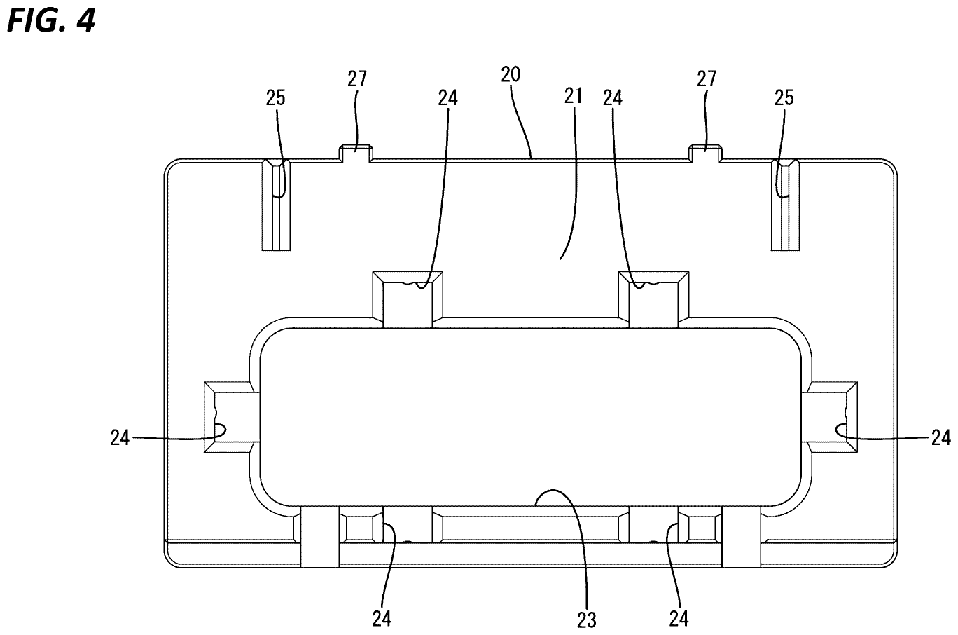

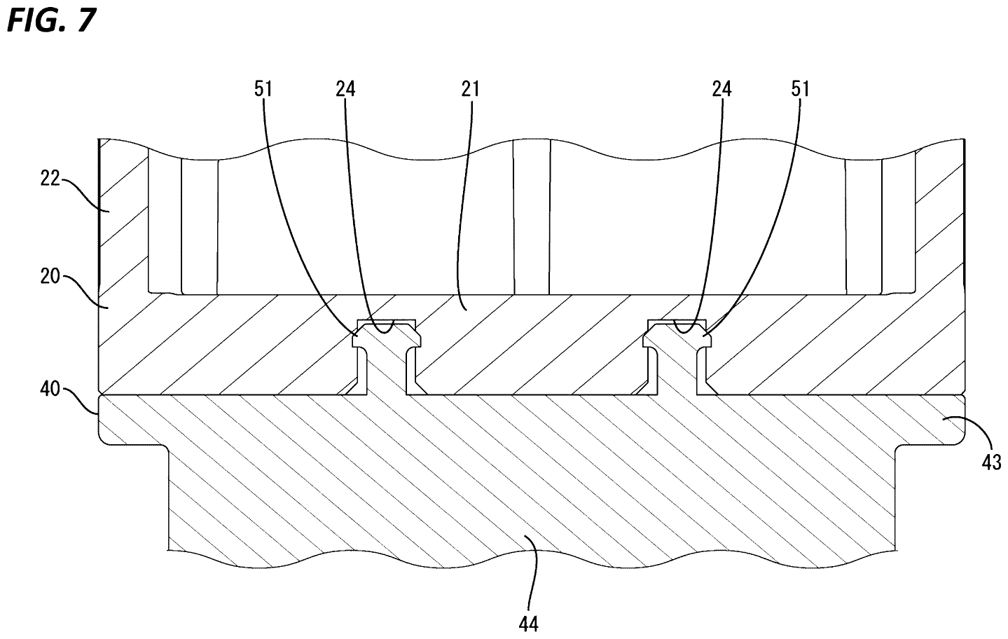

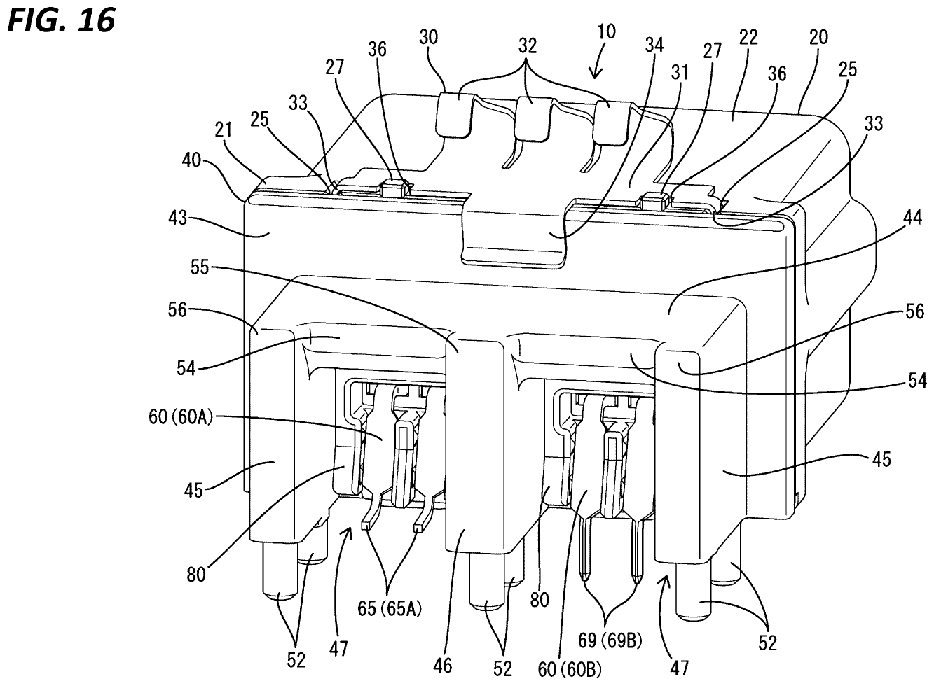

As illustrated in FIGS. 1, 3, and 4, the housing 20, which is made of a synthetic resin, includes a wall-shaped base section 21 having a thickness in the front-back direction, and a tube-shaped hood section 22 protruding forward from the base section 21. The base section 21 has a through hole 23 penetrating therethrough in the front-back direction. A plurality of press-fit recessed portions 24, which are open, are formed in a rear surface of the base section 21. Each press-fit recessed portion 24, which has a quadrilateral shape as viewed from therebehind, are arranged around the through hole 23 and are continuous to the through hole 23, and are spaced from each other. As illustrated in FIG. 7, press-fit protruding portions 51 described below of the outer conductive body 40 are put into the respective press-fit recessed portions 24 by press fit. In addition, as illustrated in FIGS. 1 and 4, a pair of left and right attachment recessed portions 25, which are open, are formed in the rear surface of the base section 21. Each attachment recessed portion 25 is in the shape of a slit groove extending in the top-bottom direction at an upper end portion of the base section 21, and is open at an upper surface of the base section 21. As illustrated in FIG. 16, attachment sections 33 described below of the connection member 30 are inserted into and attached to the respective attachment recessed portions 25. In addition, a pair of left and right positioning protrusions 27 are formed on the upper surface of the base section 21, protruding therefrom. Each positioning protrusion 27 is capable of fitting into a notch portion 36 described below of the connection member 30.

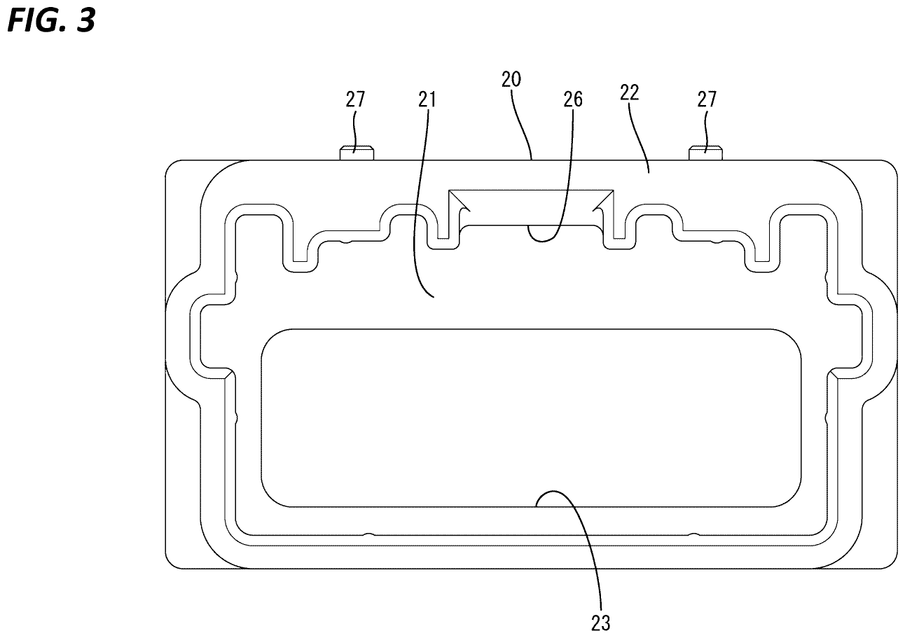

The hood section 22 is continuous to the through hole 23 and is open forward. A mating connector (not illustrated) is configured to fit into the hood section 22. As illustrated in FIG. 3, a protruding lock portion 26 is formed on an inner surface of an upper wall of the hood section 22. The lock portion 26 locks the mating connector fitted into the hood section 22.

### (Outer Conductive Body 40)

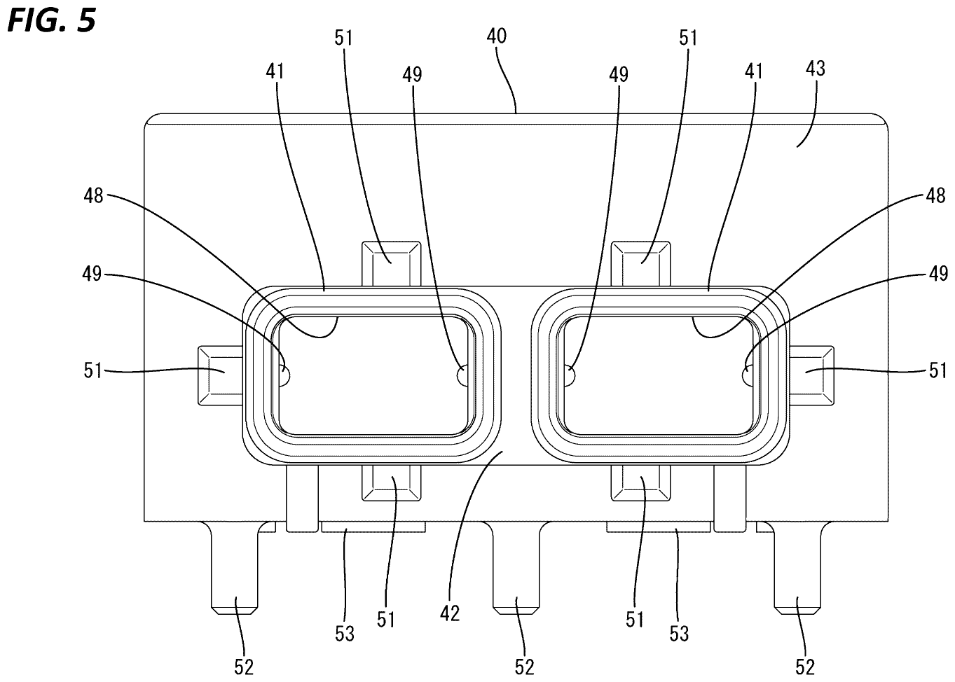

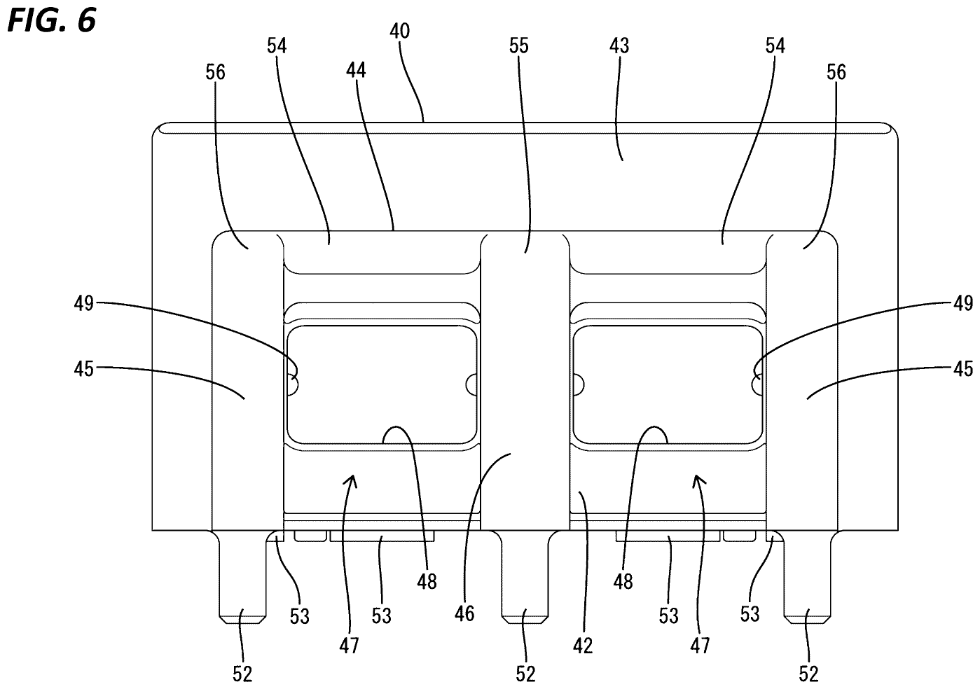

As illustrated in FIG. 5, the outer conductive body 40, which is made of a die-cast metal, includes a pair of left and right tube sections 41 having a quadrilateral tube shape, a plate-shaped linking section 42 that links the tube sections 41 together at rear ends of the tube sections, and a spreading-out section 43 that radially spreads out from the linking section 42. As illustrated in FIGS. 6 and 16, the outer conductive body 40 further has an upper wall section 44, a pair of left and right side wall sections 45, and a partition wall section 46. The upper wall section 44, the pair of left and right side wall sections 45, and the partition wall section 46 are all linked to a rear surface of the spreading-out section 43, protruding rearward from the spreading-out section 43. The upper wall section 44, which has a horizontal plate shape, is arranged along the front-back direction and left-right direction. Each side wall section 45, which has a vertical plate shape, protrudes downward from the respective one of left and right end portions of the upper wall section 44. The partition wall section 46, which has a vertical plate shape, is provided between the side wall sections 45 in the left-right direction, protruding downward from a middle portion in the left-right direction of the upper wall section 44. In the first embodiment, a thickness in the left-right direction of the partition wall section 46 is greater than a thickness in the left-right direction of each side wall section 45.

As illustrated in FIG. 16, a pair of left and right accommodation spaces 47 are delimited below the upper wall section 44 and between the respective side wall sections 45 and the partition wall section 46. In other words, the outer side in the left-right direction of each accommodation space 47 is delimited by the respective side wall section 45, and the inner side in the left-right direction of each accommodation space 47 is delimited by the partition wall section 46, and the accommodation spaces 47 are open downward and rearward. In the first embodiment, the accommodation spaces 47 are formed in the same shape (the same width in the left-right direction and the same depth in the front-back direction). Rear sections of the dielectric bodies 80 are inserted into the respective accommodation spaces 47 of the outer conductive body 40.

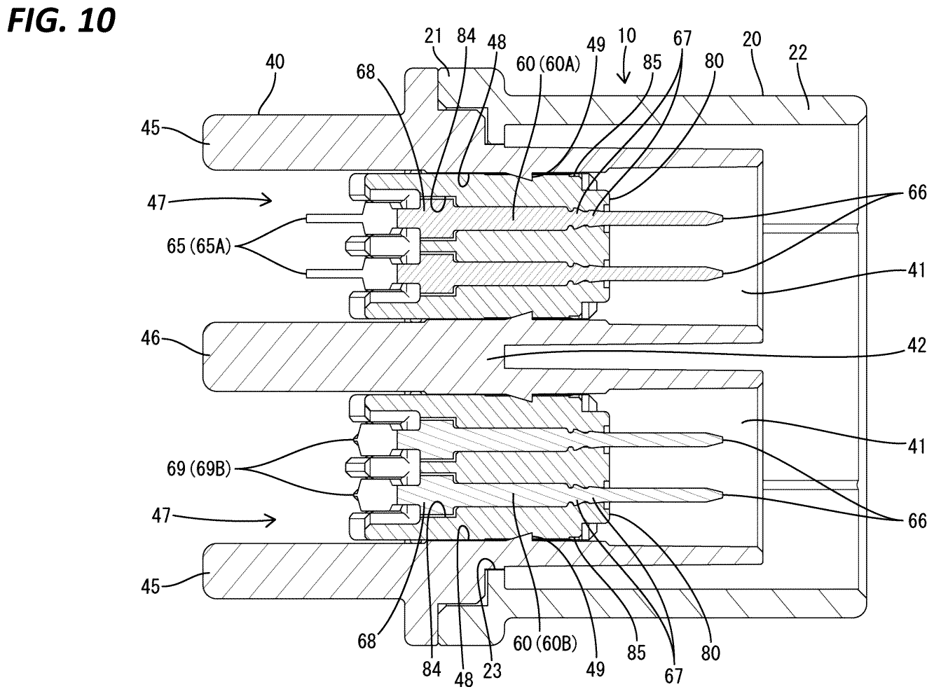

As illustrated in FIG. 5, a pair of left and right insertion holes 48 are formed in the linking section 42. Each insertion hole 48 penetrates through the linking section 42 in the front-back direction. As illustrated in FIG. 10, the inside of the tube section 41, the insertion hole 48, and the accommodation space 47 on each side are continuous to each other in the front-back direction, and the dielectric body 80 can be inserted thereinto.

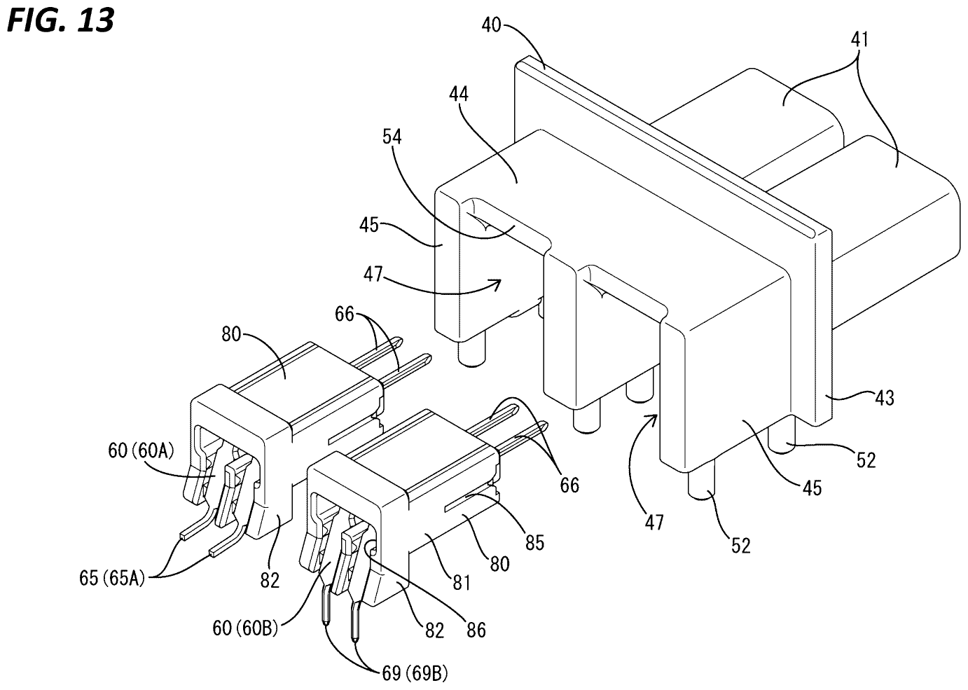

As illustrated in FIG. 5, a plurality of insertion protrusions 49 are formed on an inner surface of each tube section 41, protruding from the inner surface. The insertion protrusions 49, each of which has a curved protrusion shape, are opposite each other in the left-right direction on the inner surface of each tube section 41. As illustrated in FIG. 10, each insertion protrusion 49 is locked in a groove surface of a respective insertion groove 85 (see FIG. 13) described below of the dielectric body 80.

As illustrated in FIG. 5, a plurality of press-fit protrusion portions 51 are formed on an outer surface of the linking section 42. The press-fit protruding portions 51, which are in the shape of a prism, are arranged on top, bottom, left, and right outer surfaces of the linking section 42, one for each surface. A rear end of each press-fit protruding portion 51 is linked to the spreading-out section 43. As illustrated in FIG. 7, a front end portion of each press-fit protruding portion 51 protrudes in the left-right direction. When the tube sections 41 are inserted into the through hole 23, so that the front end portions of the press-fit protruding portions 51 are locked by the respective press-fit recessed portions 24 (see FIG. 7), the outer conductive body 40 is linked to the housing 20.

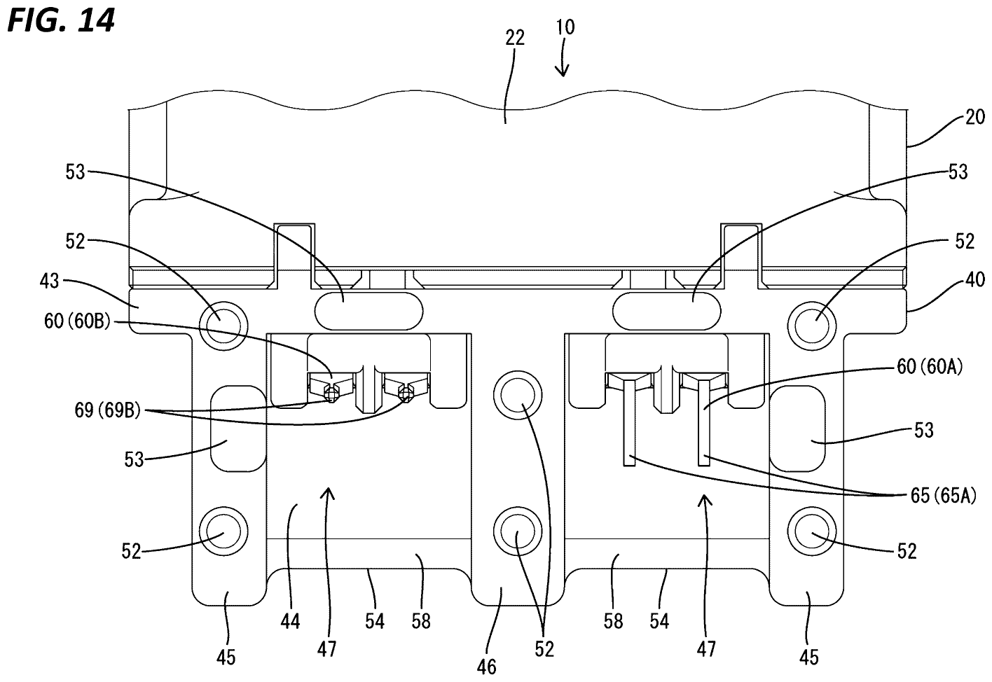

As illustrated in FIG. 16, a plurality of positioning portions 52, which are in the shape of a cylinder (pin), are formed on a lower surface of the outer conductive body 40, protruding from the lower surface. As illustrated in FIG. 2, each positioning portion 52 is configured to be inserted into a respective positioning hole 110 of the circuit board 100, and fixed to the circuit board 100 by soldering. As illustrated in FIG. 14, the positioning portions 52 at an end portion on each of the left and right sides of the outer conductive body 40 are arranged on a front end portion and a rear end portion, respectively, of a lower surface of the respective side wall section 45. A part of each positioning portion 52 on the front end portion overlays a lower surface of the spreading-out section 43. The positioning portions 52 on a middle portion in the left-right direction of the outer conductive body 40 are arranged on a front end portion and a rear end portion, respectively, of a lower surface of the partition wall section 46. If an attempt is made to attach the outer conductive body 40 to the circuit board 100 with the orientation in the front-back direction of the outer conductive body 40 reversed to be in an incorrect position, the positioning portions 52 of the partition wall section 46 strike the surface of the circuit board 100 to fail to be inserted into the corresponding positioning holes 110. Thus, the outer conductive body 40 is avoided from being attached to the circuit board 100 with the outer conductive body 40 arranged in an incorrect position.

In addition, as illustrated in FIG. 14, a plurality of ground connection portions 53 (surface-mounted portions) are formed on the lower surface of the outer conductive body 40, protruding from the lower surface. Each ground connection portion 53, which is in the shape of a flat stage having a flat lower surface, is configured to be mounted on the surface of the circuit board 100 (see FIG. 2), and connected to a ground conductive portion (not illustrated) of the circuit board 100 by soldering. A pair of the ground connection portions 53 are arranged on the lower surface of the spreading-out section 43 and spaced from each other in the left-right direction. Each ground connection portion 53 is arranged between the positioning portions 52 of a lower surface of the respective side wall section 45.

As illustrated in FIG. 16, a plurality of recessed portions 54 are formed at a rear end of the upper wall section 44. A pair of the recessed portions 54 are arranged in the left-right direction at the rear end of the upper wall section 44, corresponding to the respective accommodation spaces 47, and facing the respective accommodation spaces 47. As described below, end portions (substrate connection sections 65A and 69B described below) of the plurality of inner conductive bodies 60 placed in each accommodation space 47 can be viewed through the respective recessed portion 54 from a position above and behind the connector 10.

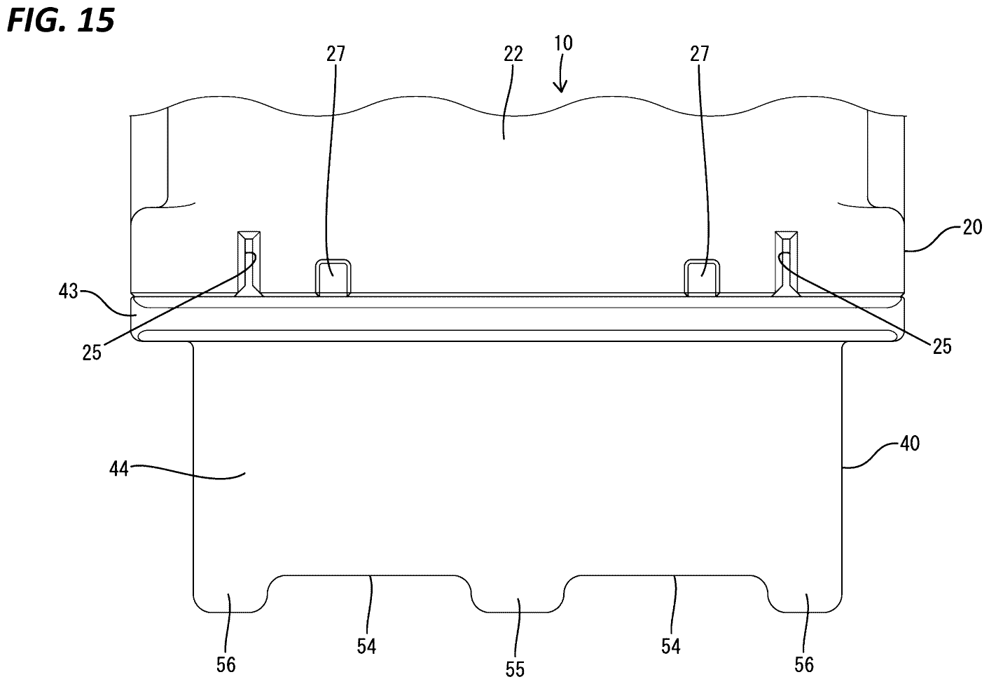

A partition section 55 that separates the recessed portions 54 in the left-right direction so that the recessed portions 54 are not continuous to each other is formed at a middle portion in the left-right direction of the rear end of the upper wall section 44. As illustrated in FIG. 6, the partition section 55 is continuous to the partition wall section 46 without a step in the top-bottom direction. A pair of left and right side end sections 56 are formed at outer end portions on the opposite sides of the left and right recessed portions 54 from the partition section 55. The side end sections 56 are also continuous to the respective side wall sections 45 without a step in the top-bottom direction. It should be noted that the side end sections 56 are positioned above the respective side wall sections 45, and therefore, are distinguished from the respective side wall sections 45 because of different height positions thereof. As illustrated in FIG. 15, rear ends of the side end sections 56 and the partition section 55 are arranged at the same position in the front-back direction. In contrast to this, a recessed end (deep end positioned on the deep side, facing rearward) of each recessed portion 54 is arranged forward of the rear end of the respective side wall section 45 and the partition section 55.

As illustrated in FIG. 15, end surfaces on both left and right sides of the partition section 55 block end surfaces on the left and right inner sides of the recessed portions 54. Corner portions of a front end portion and a rear end portion at the end surfaces on both left and right sides of the partition section 55 are rounded and curved. End surfaces on the left and right inner sides of the side end sections 56 block end surfaces on the left and right outer sides of the recessed portions 54. Corner portions of a front end portion and a rear end portion at the end surfaces on the left and right inner sides of the side end sections 56 are rounded and curved.

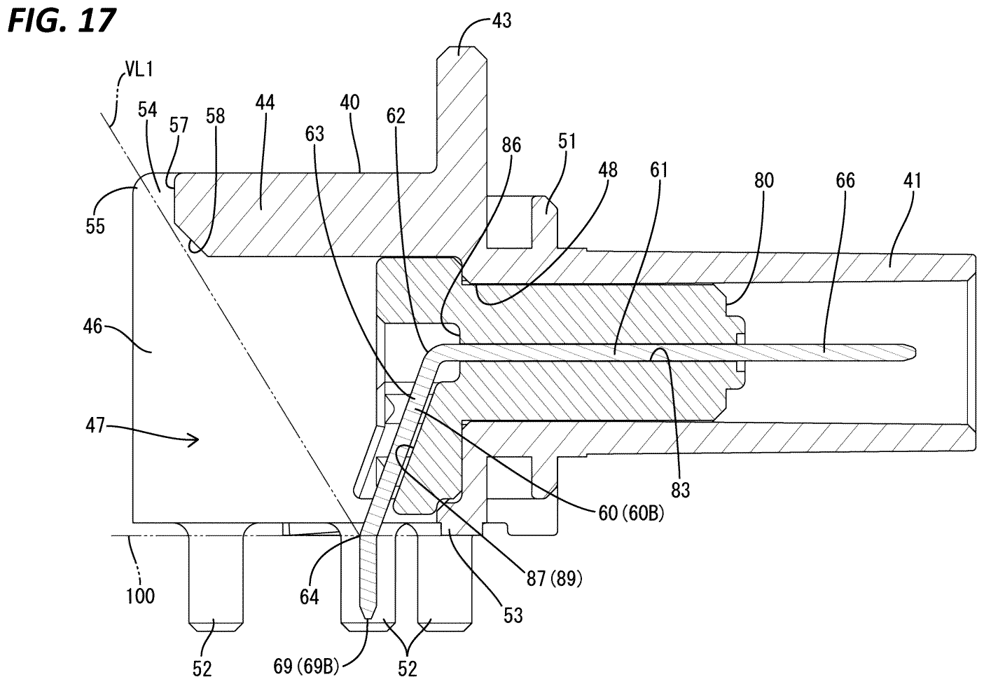

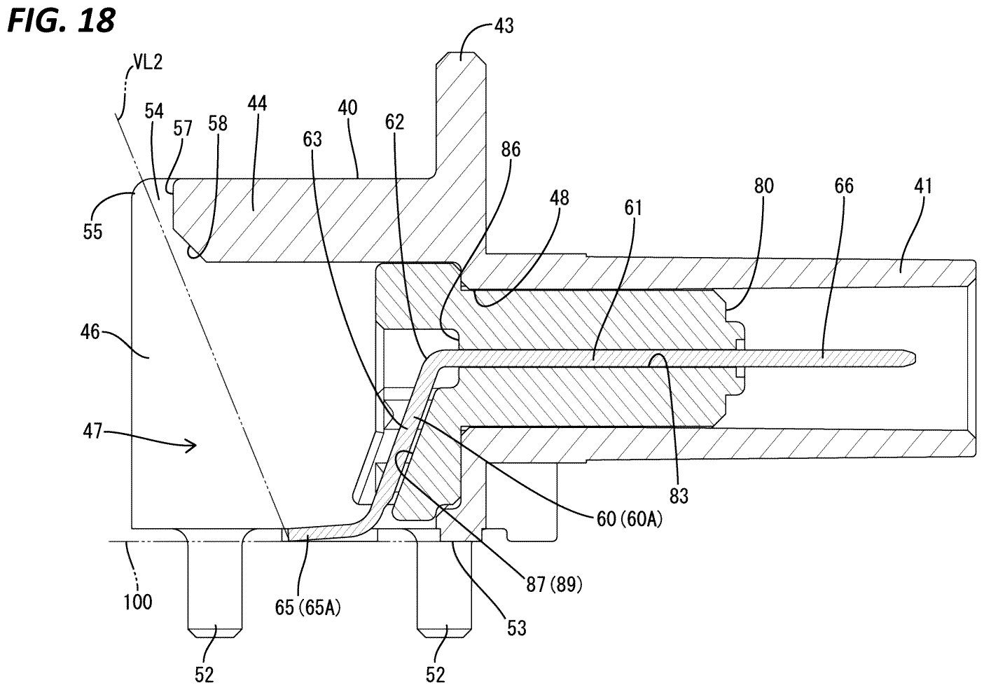

As illustrated in FIGS. 17 and 18, the recessed end of each recessed portion 54 has a vertical surface 57 arranged at an upper portion (upper portion in the thickness direction) of the upper wall section 44 and vertically along the top-bottom direction, and an inclined surface 58 arranged at a lower portion (lower portion in the thickness) of the upper wall section 44 and linearly inclined downward and rearward from the vertical surface 57. The inclined angle of the inclined surface 58 with respect to the front-back direction is within the range of 30 to 60 degrees, preferably the range of 40 to 50 degrees, and more preferably 45 degrees and around 45 degrees. If the inclined angle of the inclined surface 58 is within the above ranges, both of the visibility of an end portion (substrate connection section 65A, 69B) of the inner conductive body 60 and the shielding properties of the outer conductive body 40 can be achieved as described below.

### (Inner Conductive Body 60)

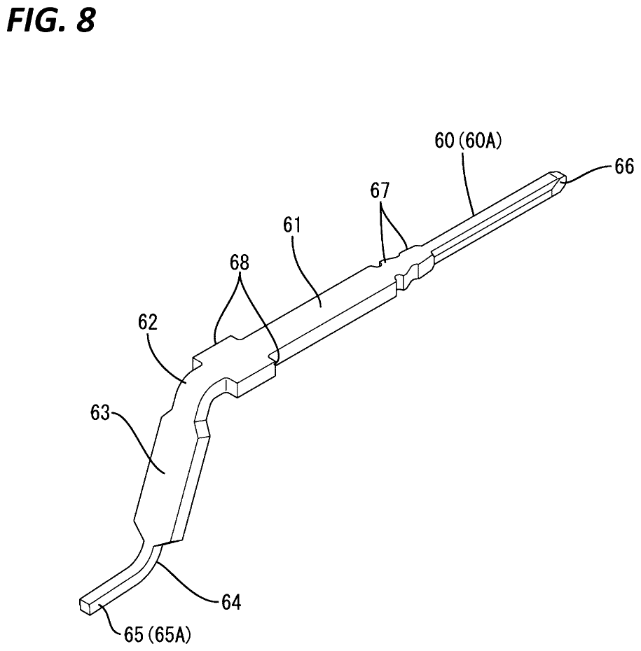

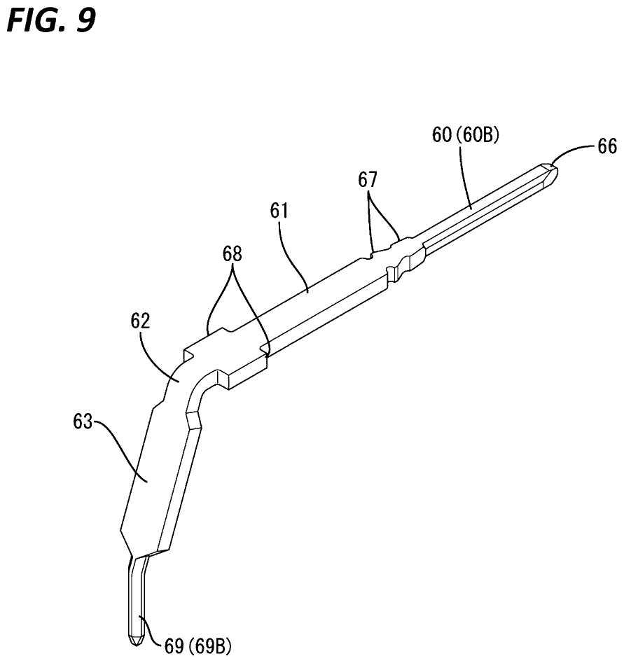

The inner conductive body 60, which is a plate material made of a conductive metal, is held by the dielectric body 80 (see FIGS. 10 and 13). In the first embodiment, as illustrated in FIGS. 8 and 9, the inner conductive bodies 60 include two kinds of terminals that are a surface-mounted terminal 60A and a through hole terminal 60B. The surface-mounted terminal 60A and the through hole terminal 60B are arranged with the plate width directions thereof oriented along the left-right direction.

As illustrated in FIG. 8, the surface-mounted terminal 60A has a first extension section 61 elongated in the front-back direction, a second extension section 63 extending from a rear end of the first extension section 61 and inclined downward and rearward with a curved upper bent section 62 interposed therebetween, and a third extension section 65 extending from a lower end of the second extension section 63 and inclined downward and rearward with a curved lower bent section 64 interposed therebetween. As illustrated in FIGS. 17 and 18, the first extension section 61 is arranged inside the dielectric body 80, except for a front end portion thereof. The upper bent section 62, the second extension section 63, the lower bent section 64, and the third extension section 65 are exposed on the rear surface side of the dielectric body 80.

The front end portion of the first extension section 61, which protrudes forward from a front surface of the dielectric body 80, is configured as a mating connection section 66 to connect to a mating terminal (an inner conductive body 60 to be mated) (not illustrated). As illustrated in FIG. 8, the first extension section 61 has a plurality of pairs of locking protrusions 67 protruding outward in the left and right direction from a position behind the mating connection section 66. Each locking protrusion 67, which is in the shape of a lug, fits into the dielectric body 80 (see FIG. 10). A front portion of the first extension section 61 including the locking protrusions 67 is wider than the mating connection section 66 in the left-right direction. A rear portion of the first extension section 61 has a pair of stopper portions 68 protruding outward in the left-right direction from a position behind the locking protrusions 67. Each stopper portion 68, which has a quadrilateral shape as viewed from above, is stopped by the dielectric body 80, abutting thereto (see FIG. 10).

As illustrated in FIG. 8, the second extension section 63 is wider than each of the first extension section 61 and the upper bent section 62 in the left-right direction. The lower bent section 64 and the third extension section 65, which have the same width dimension in the left-right direction, are narrower than the other sections of the surface-mounted terminal 60A in the left-right direction. The third extension section 65 is configured to be arranged along the surface of the circuit board 100, extending from a lower end of a rear surface of the dielectric body 80 and being inclined downward and rearward with the lower bent section 64 interposed therebetween (see FIG. 18). The third extension section 65 is configured to be connected to a conductive portion of the circuit board 100 by soldering. Thus, the third extension section 65 is configured as a surface-mounted substrate connection section 65A.

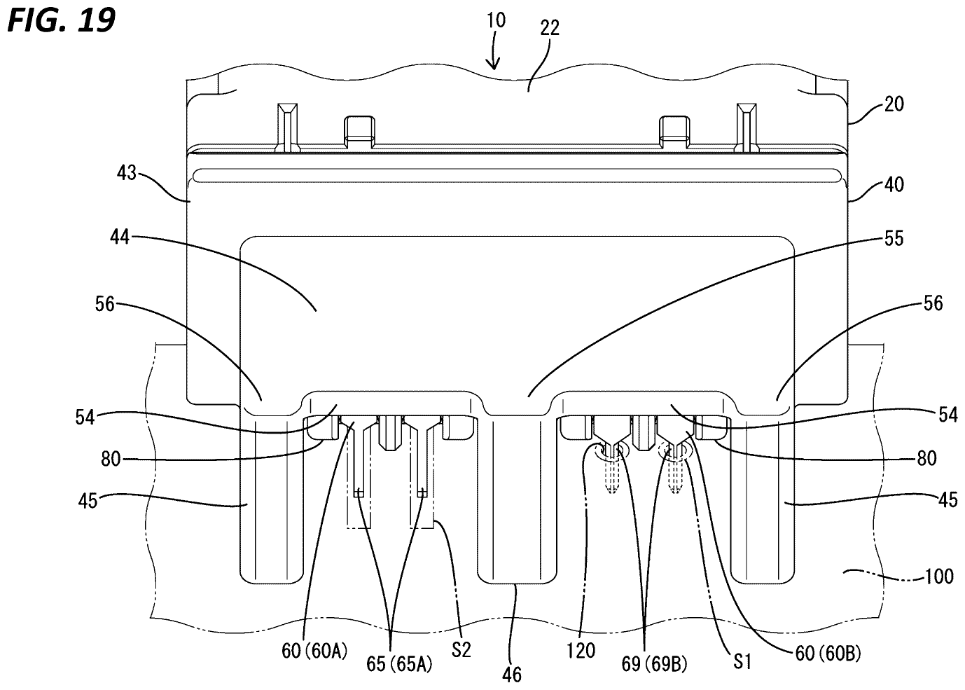

As illustrated in FIG. 9, the through hole terminal 60B has a first extension section 61, an upper bent section 62, and a second extension section 63, which have the same shapes as those of the surface-mounted terminal 60A. Thus, the shapes of the portions of the through hole terminal 60B that are brought into contact with the dielectric body 80 are the same as those of the surface-mounted terminal 60A. In addition to the first extension section 61, the upper bent section 62, and the second extension section 63, the through hole terminal 60B has a fourth extension section 69 extending vertically downward from a lower end of the second extension section 63. As illustrated in FIGS. 2 and 19, the fourth extension section 69 is configured to be inserted into a connection hole 120 formed in the circuit board 100, and then connected to a conductive portion of the circuit board 100 by soldering. Thus, the fourth extension section 69 is configured as a through hole type substrate connection section 69B. In addition, four corner portions of a cross-sectional quadrilateral shape of the fourth extension section 69 are shaped by hitting in press work. It should be noted that in the description that follows, the third extension section 65 and the fourth extension section 69 are also referred to as substrate connection sections 65A and 69B, respectively, unless these sections are particularly distinguished from each other.

### (Dielectric Body 80)

The dielectric body 80, which is made of a synthetic resin (insulating resin), is in the shape of generally a rectangular block. In the first embodiment, a single type of dielectric body 80 that has the same shape is placed in each of the two accommodation spaces 47 of the outer conductive body 40 (see FIG. 10). This single type of dielectric body 80 is capable of holding any of the surface-mounted terminal 60A and the through hole terminal 60B.

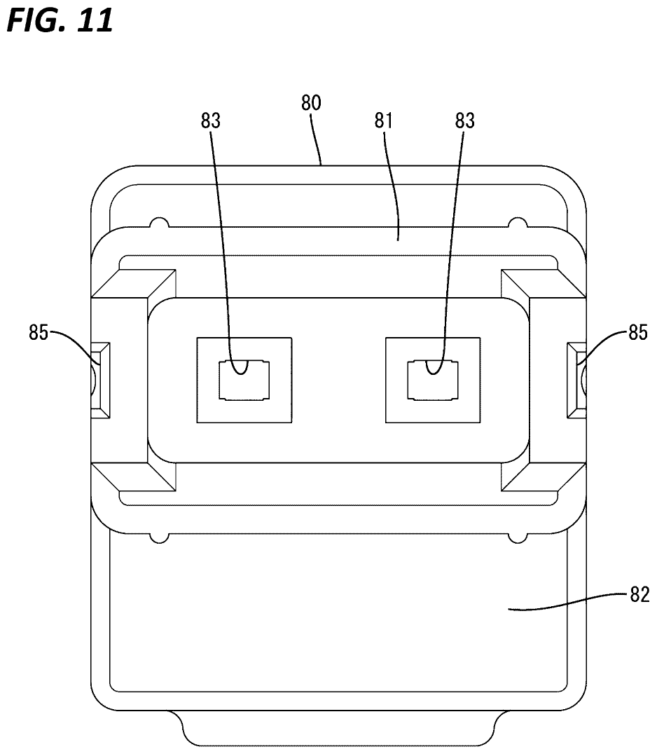

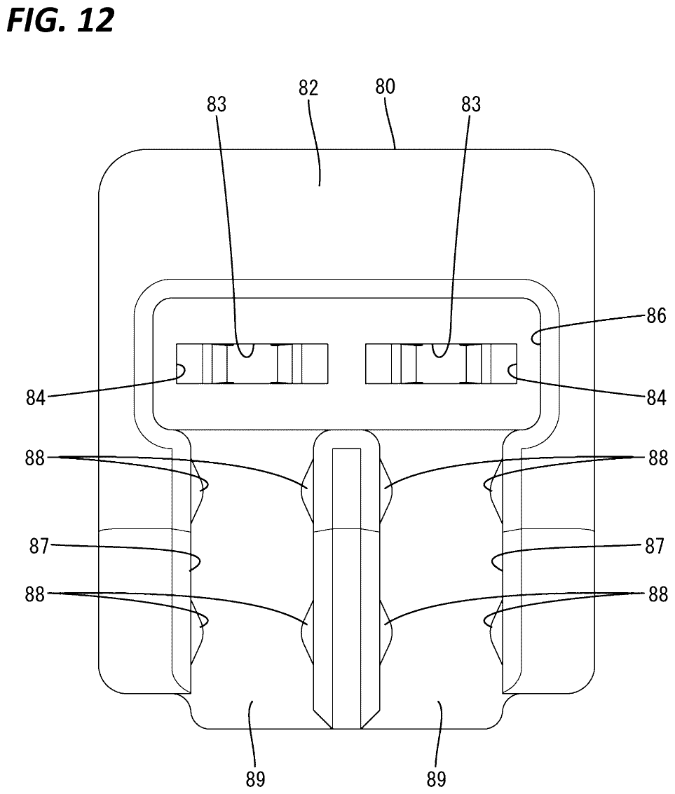

As illustrated in FIG. 1, the dielectric body 80 has a body section 81 that is in the shape of a quadrilateral as viewed from above, and a back section 82 that is linked to a rear end of the body section 81, extending in the top-bottom direction. As illustrated in FIGS. 11 and 12, the body section 81 has a pair of left and right terminal holding holes 83. As illustrated in FIGS. 17 and 18, each terminal holding hole 83 penetrates through the respective dielectric body 80 in the front-back direction. The body section 81 has a pair of left and right stopper-fitted portions 84 widened in the left-right direction at rear end portions of the respective terminal holding holes 83. The first extension section 61 of the inner conductive body 60 is inserted into the terminal holding hole 83 from behind the body section 81. The stopper portions 68 of the inner conductive body 60 are fitted with the respective stopper-fitted portions 84 (see FIG. 10) to stop the insertion operation of the inner conductive body 60. The locking protrusions 67 of the first extension section 61 are dug into an inner surface of the terminal holding hole 83 of the dielectric body 80 to be locked, and therefore, the inner conductive body 60 is prevented from being pulled rearward out of the dielectric body 80.

A pair of left and right insertion grooves 85 are formed in left and right outer side surfaces of the body section 81. Each insertion groove 85 extends in the front-back direction in the respective side surface of the body section 81, and is open at a front surface of the body section 81. As illustrated in FIG. 10, the insertion protrusion 49 of the outer conductive body 40 is dug into a groove surface of the insertion groove 85 of the body section 81. As a result, the dielectric body 80 is prevented from being pulled out of the accommodation space 47.

As illustrated in FIG. 12, a pull-out recessed portion 86 is provided at an upper portion of a rear surface of the back section 82. Each terminal holding hole 83 is open at a recessed end (deep end) of the pull-out recessed portion 86. As illustrated in FIGS. 17 and 18, the upper bent section 62 of each inner conductive body 60 is arranged in the pull-out recessed portion 86, protruding (or being exposed) rearward from the respective terminal holding hole 83.

As illustrated in FIG. 12, a pair of left and right pull-out portions 87 are a recessed portion provided at a lower portion of the rear surface of the back section 82. Each pull-out portion 87 extends in the top-bottom direction. An upper end of each pull-out portion 87 is open at a bottom surface of the pull-out recessed portion 86, and a lower end of each pull-out portion 87 is open at a bottom surface of the back section 82. A plurality of holding protrusions 88 are formed on side surfaces facing each other in the left-right direction of an inner surface of each pull-out portion 87. Each holding protrusion 88 on one of the side surfaces of each pull-out portion 87 is paired with a holding protrusion 88 on the other side surface in the left-right direction. The pairs of holding protrusions 88 are spaced from each other in the top-bottom direction. As illustrated in FIGS. 17 and 18, a groove surface (deep surface facing backward) of each pull-out portion 87 is a slope surface 89 that is inclined rearward as one proceeds from the top to the bottom. The second extension section 63 of each inner conductive body 60 is arranged in the respective pull-out portion 87 of the back section 82. The second extension section 63 of each inner conductive body 60, which is arranged along the slope surface 89 of the respective pull-out portion 87, is positioned in the left-right direction by end surfaces thereof on both the left and right sides being in contact with the respective holding protrusions 88 (see FIG. 2). As illustrated in FIGS. 17 and 18, the inclined angle of the slope surface 89 is the same or similar to that of the second extension section 63.

### (Connection Member 30)

As illustrated in FIG. 1, the connection member 30, which is a plate material made of a conductive metal, has a lateral plate section 31 extending in the left-right direction, three housing connection sections 32 linked to a front end of the lateral plate section 31, a pair of left and right attachment sections 33 protruding downward from respective end portions on both sides in the left-right direction of the lateral plate section 31, and an outer conductive body connection section 34 that protrudes rearward and downward from a middle portion in the left-right direction of a rear end of the lateral plate section 31. As illustrated in FIG. 16, the lateral plate section 31 is mounted on an upper surface of the base section 21 of the housing 20. A pair of left and right notch portions 36 are formed at a rear edge of the lateral plate section 31. As illustrated in FIG. 16, the connection member 30 is prevented from being misaligned with respect to the housing 20 by the positioning protrusions 27 fitting into the respective notch portions 36.

The housing connection sections 32 are linked to a front end of the lateral plate section 31, and are spaced from each other in the left-right direction. Each housing connection section 32 protrudes forward from the front end of the lateral plate section 31 and is folded over rearward from the front end. Each housing connection section 32, which is capable of being elastically deformed in the top-bottom direction, is configured to be connected to a wall surface of a housing (not illustrated) and thereby grounded. Each attachment section 33 is inserted into the respective attachment recessed portion 25 of the housing 20. The attachment sections 33 prevent the connection member 30 from being pulled out of the housing 20 by locking lugs 35 thereof (see FIG. 1), which protrude outward in the left-right direction, being locked in inner surfaces of the respective attachment recessed portions 25. The outer conductive body connection section 34, which is capable of being elastically deformed in the front-back direction, is brought into contact with the rear surface of the spreading-out section 43 and thereby electrically connected to the outer conductive body 40.

### (Effects of Connector 10)

As illustrated in FIG. 13, in assembly of the connector 10, each dielectric body 80, to which the respective inner conductive body 60 is attached, is inserted into the respective accommodation space 47 of the outer conductive body 40. As illustrated in FIGS. 17 and 18, the dielectric body 80 is placed in the accommodation space 47, the insertion hole 48, and the tube section 41 of the outer conductive body 40. In the first embodiment, the through hole terminals 60B are attached to one of the dielectric bodies 80 (the dielectric body 80 on the right side of FIG. 13), and the surface-mounted terminals 60A are attached to the other dielectric body 80 (the dielectric body 80 on the left side of FIG. 13). It should be noted that the through hole terminals 60B and the surface-mounted terminals 60A may be attached to the respective dielectric bodies 80 after the dielectric bodies 80 are placed in the outer conductive body 40.

The outer conductive body 40 is linked to the housing 20 after or before the dielectric bodies 80 are placed in the outer conductive body 40. As illustrated in FIG. 15, when the outer conductive body 40 is lined to the housing 20, the spreading-out section 43 of the linking section 42 faces the rear surface of the base section 21 of the housing 20 in a manner that allows the spreading-out section 43 of the linking section 42 to be in contact with the rear surface of the base section 21 of the housing 20, and a rear surface opening of each attachment recessed portion 25 is blocked by the spreading-out section 43. As illustrated in FIG. 16, the connection member 30 is attached to and lies on both of the housing 20 and the outer conductive body 40. As a result, the assembly of the connector 10 is completed.

Thereafter, as illustrated in FIG. 2, the connector 10 is attached to the circuit board 100. Each positioning portion 52 of the outer conductive body 40 is inserted into the respective positioning hole 110, and is fixed to the circuit board 100 by soldering. The fourth extension section 69 (substrate connection section 69B) of each through hole terminal 60B is inserted into the respective connection hole 120, and is connected to a conductive portion of the circuit board 100 by soldering. The third extension section 65 (substrate connection section 65A) of each surface-mounted terminal 60A is mounted on the surface of the circuit board 100, and is connected to a conductive portion of the circuit board 100 by soldering. In addition, each ground connection portion 53 of the outer conductive body 40 is mounted on the circuit board 100, and is connected to a ground conductive portion of the circuit board 100 by soldering. These soldering operations can be performed all at once by reflow soldering.

As illustrated in FIG. 14, the distances of spaces between the third extension section 65 of each surface-mounted terminal 60A and the ground connection portions 53 positioned around (forward of and outward of, in the left-right direction) said third extension section 65 are the same or similar to the distances of spaces between the fourth extension section 69 of each through hole terminal 60B and the ground connection portions 53 positioned around said fourth extension section 69. In addition, the distance of a space between the substrate connection section 65A, 69B and the ground connection portion 53 positioned forward thereof is the same or similar to the distance of a space between the substrate connection section 65A, 69B and the ground connection portion 53 positioned outward thereof in the left-right direction. As a result, a predetermined stable shielded environment can be formed between the surface-mounted terminal 60A and the through hole terminal 60B and around the substrate connection sections 65A and 69B.

As illustrated in FIGS. 17 and 19, a soldering state S1 (see FIG. 19) of the fourth extension section 69 of each through hole terminal 60B with respect to a conductive portion of the circuit board 100 can be viewed from a position above and behind the connector 10 through the inside of the recessed portion 54. In the first embodiment, as illustrated in FIG. 17, an imaginary straight line VL1 extending upward and rearward from a rear end (rear end on the circuit board 100) of the fourth extension section 69 of each through hole terminal 60B through any point in the inside of the recessed portion 54 is inclined within the range of 45 to 75 degrees, preferably the range of 50 to 70 degrees, and more preferably the range of 55 to 65 degrees with respect to the front-back direction. Therefore, by viewing the rear end of the fourth extension section 69 of each through hole terminal 60B from a position above and behind the connector 10 along the imaginary straight line VL1, it can be checked whether or not a portion including the rear end of the fourth extension section 69 is appropriately soldered to a conductive portion of the circuit board 100.

Likewise, as illustrated in FIGS. 18 and 19, a soldering state S2 (see FIG. 19) of the third extension section 65 of each surface-mounted terminal 60A with respect to a conductive portion of the circuit board 100 can be viewed from a position (the viewpoint of the operator or the position of a camera) above and behind the connector 10 through the inside of the recessed portion 54. In the first embodiment, an imaginary straight line VL2 extending upward and rearward from the rear end of the third extension section 65 of each surface-mounted terminal 60A through any point in the inside of the recessed portion 54 is inclined within the range of 50 to 80 degrees, preferably the range of 55 to 75 degrees, and more preferably the range of 60 to 70 degrees with respect to the front-back direction. Therefore, by viewing the rear end of the third extension section 65 of each surface-mounted terminal 60A from a position above and behind the connector 10 along the imaginary straight line VL2, it can be checked whether or not a portion including the rear end of the third extension section 65 is appropriately soldered to a conductive portion of the circuit board 100.

In other words, as illustrated in FIG. 19, the soldering state S1 of the substrate connection section 69B of each through hole terminal 60B, which is arranged in one of the accommodation spaces 47, can be checked through a line of sight corresponding to the imaginary straight line VL1 passing through the recessed portion 54 corresponding to said accommodation space 47. Likewise, the soldering state S2 of the substrate connection section 65A of each surface-mounted terminal 60A, which is arranged in the other accommodation spaces 47, can be checked through a line of sight corresponding to the imaginary straight line VL2 passing through the recessed portion 54 corresponding to said accommodation space 47. Because the inclined angles of the imaginary straight lines VL1 and VL2 with respect to the front-back direction are smaller than the inclined angle of the inclined surface 58 with respect to the front-back direction, the range of view along the imaginary straight line VL1, VL2 passing through the recessed portion 54 is not blocked by the inclined surface 58, resulting in excellent visibility when the state of the substrate connection section 65A, 69B is viewed.

As described above, the connector 10 of the first embodiment includes the inner conductive body 60, the dielectric body 80 surrounding the inner conductive body 60, and the outer conductive body 40 surrounding the dielectric body 80. The inner conductive body 60 has the substrate connection section 65A, 69B arranged and exposed on the rear surface side of the dielectric body 80. The outer conductive body 40 has the upper wall section 44, the pair of the side wall sections 45 protruding downward from the end portions in the left-right direction of the upper wall section 44, and the partition wall section 46 arranged between the pair of side wall sections 45. A space below the upper wall section 44 and between the pair of side wall sections 45 is partitioned into the plurality of accommodation spaces 47 by the partition wall section 46. The rear portion of the dielectric body 80 and the substrate connection section 65A, 69B are arranged in the respective one of the plurality of accommodation spaces 47. The rear end of the upper wall section 44 has the plurality of recessed portions 54 arranged, corresponding to the respective ones of the plurality of accommodation spaces 47, and the partition section 55 arranged between the recessed portions 54 adjacent to each other in the left-right direction.

With the above configuration, the state of the substrate connection section 65A, 69B (e.g., the soldering state S1, S2 of the substrate connection section 65A, 69B with respect to the circuit board 100) can be checked from a position above and behind the connector 10 through the recessed portion 54 of the upper wall section 44. In particular, because the plurality of accommodation spaces 47, in which the rear portions of the respective dielectric bodies 80 are arranged, are formed, and the partition section 55 is arranged between the adjacent recessed portions 54, a decrease in the shielding properties of the outer conductive body 40 can be reduced compared to the case in which the partition section 55 is not provided. In addition, because the partition section 55 is formed integrally with and continuously to the partition wall section 46, the strength of the partition section 55 can be improved compared to the case in which the partition section 55 is separately formed.

In addition, in the first embodiment, the imaginary straight line VL1, VL2 extending upward and rearward from the position on the circuit board 100 of the rear end of the substrate connection section 65A, 69B and passing through the recessed portion 54 is inclined within the range of 45 to 80 degrees with respect to the front-back direction. Therefore, the state of the substrate connection section 65A, 69B can be easily viewed from a position above and behind the connector 10 in a direction along the imaginary straight line VL1, VL2. In addition, the range in which the recessed portion 54 is formed at the upper wall section 44 can be reduced to an appropriate range so that the imaginary straight line VL1, VL2 is inclined at the above angle, and therefore, the shielding properties of the outer conductive body 40 can be more reliably ensured.

In particular, the inner conductive body 60 includes the through hole terminal 60B having the substrate connection section 69B extending downward from the dielectric body 80, and the surface-mounted terminal 60A having the substrate connection section 65A extending downward and rearward from the dielectric body 80. Therefore, the states of the substrate connection sections 65A and 69B of the surface-mounted terminal 60A and the through hole terminal 60B can be easily viewed from a position above and behind the connector 10 in a direction along the imaginary straight lines VL1 and VL2, respectively.

Furthermore, in the first embodiment, the through hole terminal 60B is arranged in one of the accommodation spaces 47, and the surface-mounted terminal 60A is arranged in the other accommodation space 47. Because the dielectric bodies 80 have the same shape, even in the case in which the through hole terminal 60B and the surface-mounted terminal 60A coexist, the identical dielectric body 80 can be used for both of the terminals, and therefore, the manufacturing cost and management cost of the dielectric bodies 80 can be reduced.

Furthermore, the recessed end of the recessed portion 54 has the vertical surface 57 arranged vertically at the upper portion of the upper wall section 44, and the inclined surface 58 arranged at the lower portion of the upper wall section 44 and inclined downward and forward from the vertical surface 57. Because the recessed end of the recessed portion 54 has the inclined surface 58 in addition to the vertical surface 57, visibility when the state of the substrate connection section 65A, 69B is viewed from a position above and behind the connector 10 can be improved. In addition, by adjusting the position in the front-back direction of the vertical surface 57 at the upper wall section 44, both the shielding properties and the visibility can be obtained.

### Second Embodiment

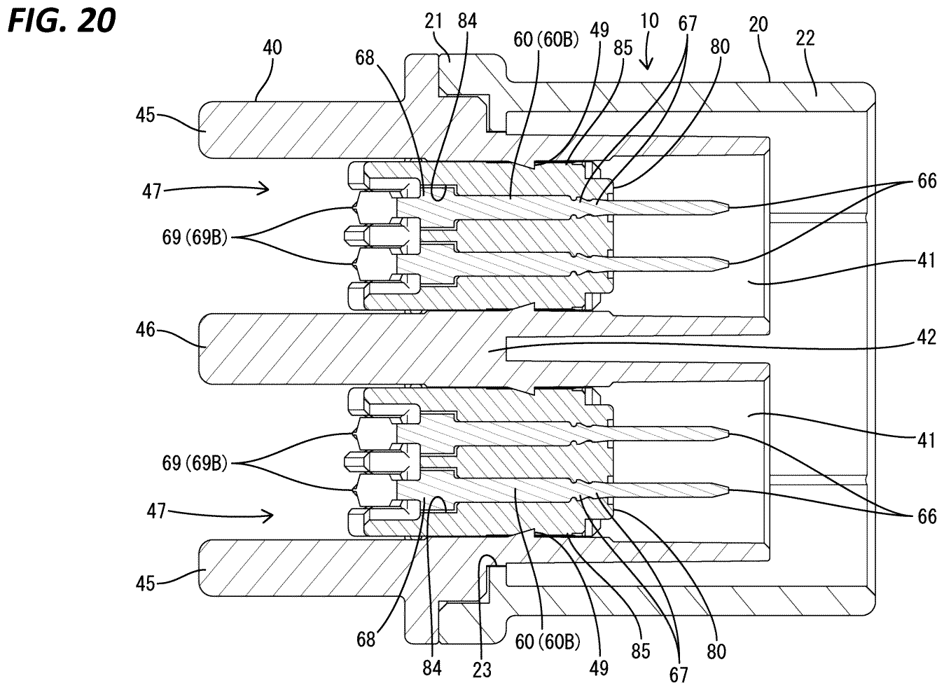

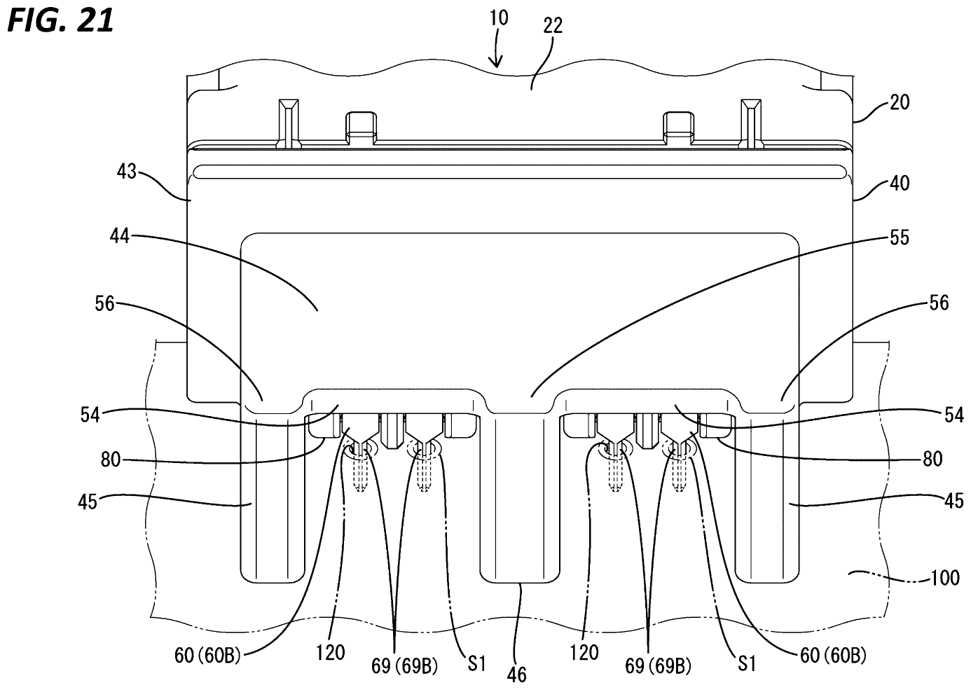

As illustrated in FIGS. 20 and 21, a connector 10 according to a second embodiment of the present disclosure is configured such that the inner conductive bodies 60 include only the through hole terminals 60B. Each of the through hole terminal 60B, the dielectric body 80, the outer conductive body 40, the housing 20, and the connection member 30 has a structure similar to that of the first embodiment.

A pair of the two through hole terminals 60B are attached to each of the two dielectric bodies 80. As described in the first embodiment, the dielectric bodies 80 have the same shape. The fourth extension section 69 (substrate connection section 69B) of each through hole terminal 60B protrudes downward from a lower end of the slope surface 89 of the respective dielectric body 80 with the through hole terminal 60B attached to the dielectric body 80. Each dielectric body 80, to which the respective through hole terminals 60B are attached, is inserted into and placed in the respective accommodation space 47 of the outer conductive body 40. When the connector 10 is attached to the circuit board 100, the fourth extension section 69 of each through hole terminal 60B is inserted into the respective connection hole 120 of the circuit board 100, and is connected to a conductive portion of the circuit board 100 by soldering. As illustrated in FIG. 21, the soldering state S1 of the fourth extension section 69 of each through hole terminal 60B on the surface of the circuit board 100 can be viewed from a position above and behind the connector 10 through the inside of the recessed portion 54 facing the respective accommodation space 47 along the imaginary straight line VL1.

### Third Embodiment

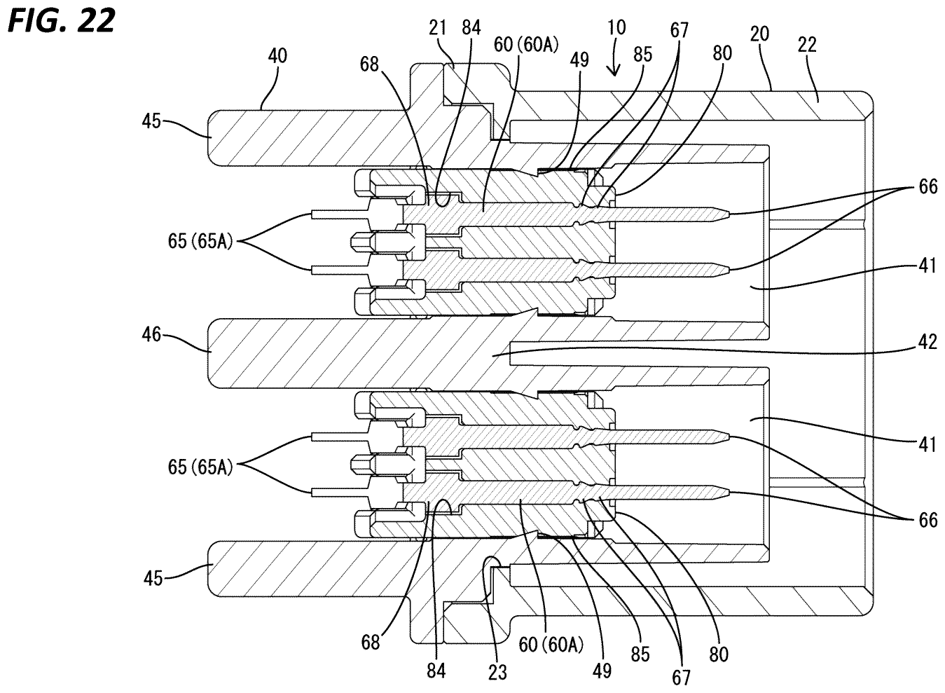

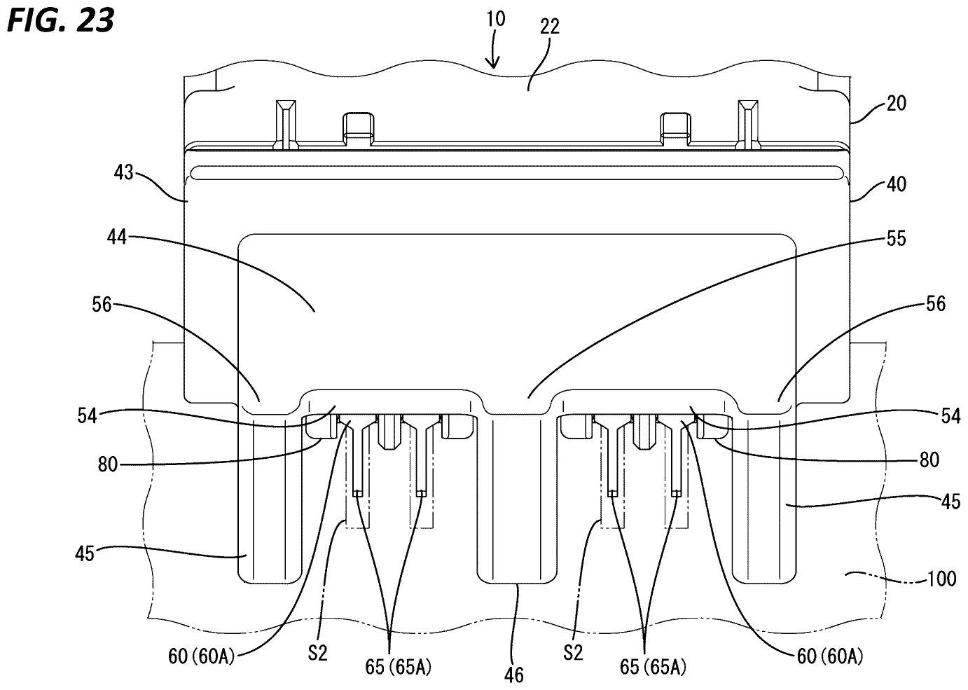

As illustrated in FIGS. 22 and 23, a connector 10 according to a third embodiment of the present disclosure is configured such that the inner conductive bodies 60 include only the surface-mounted terminals 60A. Each of the surface-mounted terminal 60A, the dielectric body 80, the outer conductive body 40, the housing 20, and the connection member 30 has a configuration similar to that of the first embodiment.

A pair of the two surface-mounted terminals 60A are attached to each of the two dielectric bodies 80. As described above in the first embodiment, the dielectric bodies 80 have the same shape. The third extension section 65 (substrate connection section 65A) of each surface-mounted terminal 60A protrudes downward and rearward from the lower end of the slope surface 89 of the respective dielectric body 80 with the surface-mounted terminal 60A attached to the dielectric body 80. Each dielectric body 80, to which the respective surface-mounted terminals 60A are attached, is inserted into and placed in the respective accommodation space 47 of the outer conductive body 40. When the connector 10 is attached to the circuit board 100, the third extension section 65 of each surface-mounted terminal 60A is arranged along the surface of the circuit board 100, and is connected to a conductive portion of the circuit board 100 by soldering. As illustrated in FIG. 23, the soldering state S2 of the third extension section 65 of each surface-mounted terminal 60A on the surface of the circuit board 100 can be viewed from a position above and behind the connector 10 through the inside of the recessed portion 54 facing the respective accommodation space 47 along the imaginary straight line VL2.

### Other Embodiments of the Present Disclosure

The first to third embodiments disclosed herein are to be considered in all aspects as illustrative and not restrictive.

In the first to third embodiments, a single partition wall section is formed between the pair of left and right side wall sections. In contrast to this, according to another embodiment, a plurality of (two or more) partition wall sections may be formed between the pair of left and right side wall sections. In the case in which a plurality of partition wall sections are formed in an outer conductive body, at least three accommodation spaces are formed between the pair of left and right side wall sections.

In the first to third embodiments, the partition section is formed above the partition wall section and is continuous to the partition wall section without a step. In contrast to this, according to another embodiment, the partition section may be formed above the partition wall section and may be continuous to the partition wall section with a step interposed therebetween or may not be continuous to the partition wall section.

In the first to third embodiments, the recessed end of the recessed portion includes a vertical surface and an inclined surface. In contrast to this, according to another embodiment, the recessed end of the recessed portion may include only a vertical surface. Alternatively, the recessed end of the recessed portion may include only an inclined surface.

In the first to third embodiments, the soldering state of the substrate connection section with respect to the circuit board can be viewed through the recessed portion. In contrast to this, according to another embodiment, only the arrangement of the substrate connection section with respect to the circuit board may be viewed through the recessed portion.

In the first to third embodiments, one of the through hole terminal and the surface-mounted terminal is attached to the dielectric body. In contrast to this, according to another embodiment, both of the through hole terminal and the surface-mounted terminal may be attached to the dielectric body.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising: inner conductive bodies; dielectric bodies surrounding the inner conductive bodies; and an outer conductive body surrounding the dielectric bodies, wherein
each inner conductive body has a substrate connection section arranged and exposed on a rear surface side of the respective dielectric body,
the outer conductive body has an upper wall section, a pair of side wall sections protruding downward from a left and a right end portion of the upper wall section, and a partition wall section arranged between the pair of side wall sections,
a space below the upper wall section and between the pair of side wall sections is partitioned into a plurality of accommodation spaces by the partition wall section,
a rear section of each dielectric body and each substrate connection section are arranged in the respective one of the plurality of accommodation spaces, and
a rear end of the upper wall section has a plurality of recessed portions arranged, corresponding to the respective ones of the plurality of accommodation spaces, and a partition section arranged between ones of the plurality of recessed portions adjacent to each other in a left-right direction.

2. The connector according to claim 1, wherein
the partition section is formed above the partition wall section and is continuous to the partition wall section.

3. The connector according to claim 1, wherein
an imaginary straight line extending upward and rearward from a rear end position on a circuit board of the substrate connection section and passing through the recessed portion is inclined within the range of 45 to 80 decrees with respect to a front-back direction.

4. The connector according to claim 3, wherein
the inner conductive bodies are a surface-mounted terminal having the substrate connection section protruding downward and rearward from the dielectric body.

5. The connector according to claim 3, wherein
the inner conductive bodies are a through hole terminal having the substrate connection section protruding downward from the dielectric body.

6. The connector according to claim 3, wherein
the inner conductive bodies are a surface-mounted terminal having the substrate connection section extending downward and rearward from the dielectric body, and a through hole terminal having the substrate connection section extending downward from the dielectric body.

7. The conductor according to claim 6, wherein
the through hole terminal is arranged in one of the plurality of accommodation spaces, and the surface-mounted terminal is arranged in another of the plurality of accommodation spaces, and
the dielectric bodies having the same shape are placed in the respective ones of the plurality of accommodation spaces.

8. The connector according to claim 1. wherein
a recessed end of the recessed portion has a vertical surface arranged vertically at an upper portion of the upper wall section, and an inclined surface arranged at a lower portion of the upper wall section and inclined downward and forward from the vertical surface.
